(19) United States
(12) Patent Application Publication
(10) Pub. No.: US 2013/0122341 A1
(43) Pub. Date: May 16, 2013

(54) BATTERY OF ACCUMULATORS OF EASY DESIGN AND ASSEMBLY

(71) Applicants: Lionel De Paoli, Odenas (FR); Daniel Chatroux, Teche (FR); Matthieu Desbois-Renaudin, Villard De Lans (FR)

(72) Inventors: Lionel De Paoli, Odenas (FR); Daniel Chatroux, Teche (FR); Matthieu Desbois-Renaudin, Villard De Lans (FR)

(73) Assignee: COMMISSARIAT A L'ENERGIE ATOMIQUE ET AUX ENERGIES ALTERNATIVES, Paris (FR)

(21) Appl. No.: 13/812,390

(22) PCT Filed: Jul. 25, 2011
(86) PCT No.: PCT/EP2011/062769

§ 371 Date: Jan. 25, 2013

(30) Foreign Application Priority Data
Jul. 29, 2010 (FR) 1056280

(51) Int. Cl. H01M 2/10

(52) U.S. Cl. CPC H01M 2/105
USPC 429/99

(57) ABSTRACT

A battery comprises electrochemical accumulators of which a subset defines a first stage of electrically parallel-connected accumulators and another subset defines a second stage of electrically parallel-connected accumulators. Each accumulator of the first stage is series-connected to an accumulator of the second stage by a third distinct electrical connector defined by a through-bore.

The invention pertains to batteries of electrochemical accumulators. These may be used for example in the field of electrical and hybrid transport or in embedded systems.

An electrochemical accumulator usually has a nominal voltage of the following magnitude:

1.2 V for NiMH type batteries,

3.3 V for an iron phosphate, lithium-ion, LiFePO4 technology,

4.2 V for a lithium-ion technology based on cobalt oxide.

These nominal voltages are too low for the requirements of most systems to be powered. To obtain the appropriate voltage level, several accumulators are placed in series. To obtain high power and capacity levels, several accumulators are placed in parallel. The number of stages (number of accumulators in series) and the number of accumulators in parallel in each stage vary as a function of the voltage, the current and the capacity desired for the battery. The association of several accumulators is called a battery of accumulators.

When designing a battery of accumulators, it is sought to obtain a certain level of power at a defined operating voltage. To maximize the power, the current delivered is maximized by reducing the internal parasitic resistance of the battery to the utmost possible extent.

Lithium-ion type batteries are well suited to transport applications because of their capacity to store substantial energy in a small mass. Among lithium-ion battery technologies, iron-phosphate-based batteries offer high level of intrinsic security as compared with cobalt-oxide-based lithium-ion batteries, with the disadvantage of slightly lower energy per unit mass. Besides, lithium-ion batteries also have a minimum voltage below which an accumulator can suffer deterioration.

In practice, for high-power applications, it is necessary to specifically design a battery having an output voltage, capacity and power adapted to this application. The designing implies especially the choice of the type of accumulator, the choice of a number of series-connected accumulator stages, and the choice of a number of parallel-connected branches.

The manufactured battery must meet a certain number of constraints related for example to mechanical resistance, security against heating, the appearance of short circuits or the presence of foreign bodies, electrical losses limited to the utmost possible extent, and a space requirement and a cost price limited to the utmost possible extent.

In order to ensure the mechanical maintenance of the accumulators, security against the appearance of foreign bodies or against the consequences of overheating, it is usual to place the accumulators of a battery in a case. The case comprises a plurality of parallel cylindrical tubes designed to receive the accumulators. The tubes enable the accumulators to be maintained transversally. The tubes also insulate the accumulators from one another to prevent the heating of an accumulator from spreading to adjacent accumulators. Accumulators with insulating sleeves of lower performance or even accumulators without sleeves can thus be used. The casing forms an axial stop at the level of a first end of the tubes. The connections between the accumulators are obtained at a second end of the tubes. To this end, each accumulator has an electrical connector fixedly joined to its first terminal (terminal positioned at the first end of the tube) and extending up to the second end of the tube. The accumulators are then connected together in an appropriate circuit so as to form several stages and branches and so as to connect a monitoring circuit.

The designing and manufacture of such a battery prove to be particularly complicated, and this is a major obstacle for making prototypes. The designing of the casing is fairly lengthy whereas the casing itself is not decisive for the electrical properties of the battery. Such a battery is thus ill-suited to a modification of its design and its components are most frequently far too specific to be capable of being reintegrated into other battery designs. Furthermore, the assembling of the battery can even prove to be dangerous since the accumulators have to be kept charged to prevent their corrosion and destruction. In addition, such a battery remains fairly subject to variations in electrical properties of the different accumulators. Besides, such a battery takes up a fairly large amount of space, and this which proves to be particularly disadvantageous in certain applications such as automobile applications.

The document EP1109237 describes a battery module including accumulators. The accumulators are kept between two facing holders and have recesses receiving the ends of the accumulators. The holders are fixedly joined by rods and screws. At the holder, one end of the accumulators is placed flat against a first face of the holder. Electrical connectors are positioned against a second face of the holder to series-connect adjacent accumulators.

When several modules of this type have to be series-connected to meet the requirements of voltage to be delivered, power connections have to be implanted to series-connect two terminals of the modules. To limit the resistance induced by these series connections system with the accumulators, the section of these connections has to be great, and this has a detrimental effect on the overall space requirement of the battery. Besides, the housing of such an association of modules is not more optimal either in terms of space requirement.

The invention seeks to overcome one or more of these drawbacks. The invention thus relates to a battery of accumulators comprising:
first electrochemical accumulators having first and second axial ends at which there are respectively made first and second electrical connection terminals;
second electrochemical accumulators having first and second axial ends at which there are respectively made first and second electrical connection terminals;
first and second holders disposed so as to be facing each other, a third holder disposed so as to be facing the second holder, the first to third holders being electrically insulating, each holder comprising a plurality of recesses, and passages made between each recess and the recesses adjacent to it;
the second holder comprising a plurality of recesses made in a first face and a plurality of recesses made in a second face, the recesses of the first and second faces facing each other and communicating by through-bores;
the first axial end of said first accumulators being placed in a respective recess of the first holder, the second axial end of the first accumulators being placed in a respective recess of the second holder, the first axial end of said second accumulators being placed in a respective recess of the second face of the second holder, the second axial end of said second accumulators being placed in a respective recess of the third holder;
said recesses being configured to restrict the axial and transversal motions of the accumulators and keep the accumulators separated by an air gap, each holder comprising side walls restricting the transversal motions of the accumulators in the recesses, battery in which said passages between the adjacent recesses are formed by grooves passing through said lateral walls;
at least one mounted rod fixedly joining together the first and second holders, at least one mounted rod fixedly joining the second and third holders;
at least one first electrical connector passing through one of the passages of the first holder and electrically series-connecting two adjacent accumulators among the first accumulators;
at least one second electrical connector passing through one of said passages of said third holder and electrically series-connecting two adjacent accumulators among the second accumulators;
at least third electrical connectors, the first accumulators comprising at least one first stage of electrically parallel-connected accumulators, the second accumulators comprising at least one second stage of electrically parallel-connected accumulators, each accumulator of the first stage being series-connected to an accumulator of the second stage by a third distinct electrical connector by means of a through-bore.

According to one variant, said holders are without walls surrounding the median part of the accumulators.

According to yet another variant, the median parts of two adjacent accumulators are separated only by an air gap.

According to another variant, each holder comprises at least one through-hole extending in parallel to the accumulators and disposed between recesses of the holder so as to open into an air gap between accumulators.

According to yet another variant, each holder comprises at least one passage extending transversally between a recess and the periphery of the holder.

According to one variant, the first accumulators comprise at least two stages of electrically series-connected accumulators, said two stages each comprising at least two electrically parallel-connected accumulators, said first electrical connector being a metal plate series-connecting said stages and parallel-connecting said accumulators of the two stages, said metal plate comprising a fuse section forming the parallel connection and passing through one of said passages between adjacent recesses.

According to yet another variant, the fuse section is sized to open the electrical connection between two of said accumulators in parallel when one of these accumulators is short-circuited.

According to one variant, the fuse section is sized to conduct current when one of said parallel-connected accumulators forms an open circuit.

According to yet another variant, the battery comprises a charging and charge-balancing circuit connected to the terminals of each of the series-connected stages.

According to yet another variant, the passages between adjacent recesses extend appreciably up to half of the thickness of the holders.

According to yet another variant, the recesses of a holder are laid out in matrix form in forming rows and columns.

According to yet another variant, each of said first accumulators is series-connected to one of said second accumulators by means of a third distinct electrical connector.

### BRIEF DESCRIPTION OF THE DRAWINGS

Other features and advantages of the invention shall appear more clearly from the description made here below by way of an indication that is in no way exhaustive, with reference to the appended drawings, of which:

FIG. 1 is a view in perspective of a battery according to one mode of implementation of the invention;

FIG. 2 is a view of an external face of an end holder of the battery of FIG. 1;

FIG. 3 is a view of an internal face of the end holder illustrated in FIG. 2;

FIG. 4 is a partial view in perspective of the end holder illustrated in FIG. 2;

FIG. 5 is a partial view in cross-section of the end holder of FIG. 2;

FIG. 6 is a partial view in cross-section of the battery of FIG. 1 at the level of an end holder;

FIG. 7 is a view of a first face of an intermediate holder of the battery of FIG. 1;

FIG. 8 is a view of a second face of the intermediate holder of FIG. 7;

FIG. 9 is a view in perspective of the intermediate holder of FIG. 7;

FIG. 10 is a partial view in cross-section of the intermediate holder of FIG. 7;

FIG. 11 is a partial view in cross-section of the battery of FIG. 1 at the level of an intermediate holder;

FIG. 12 is a view in cross-section of the intermediate holder of FIG. 7;

FIG. 13 is a view in cross-section of the battery of FIG. 1 at the level of the intermediate holder;

FIG. 14 is a schematic view of the electrical connections of the battery of FIG. 1;

FIG. 15 is a side view schematically representing the layout and the connection of the accumulators in the battery of FIG. 1;

FIG. 16 is a front view schematically representing the layout of the accumulators in the battery of FIG. 1;

FIG. 17 is a front view of a first type of foil providing for an electrical connection between accumulators of the battery of FIG. 1;

FIG. 18 is a front view of a second type of foil providing for an electrical connection between accumulators of the battery of FIG. 1.

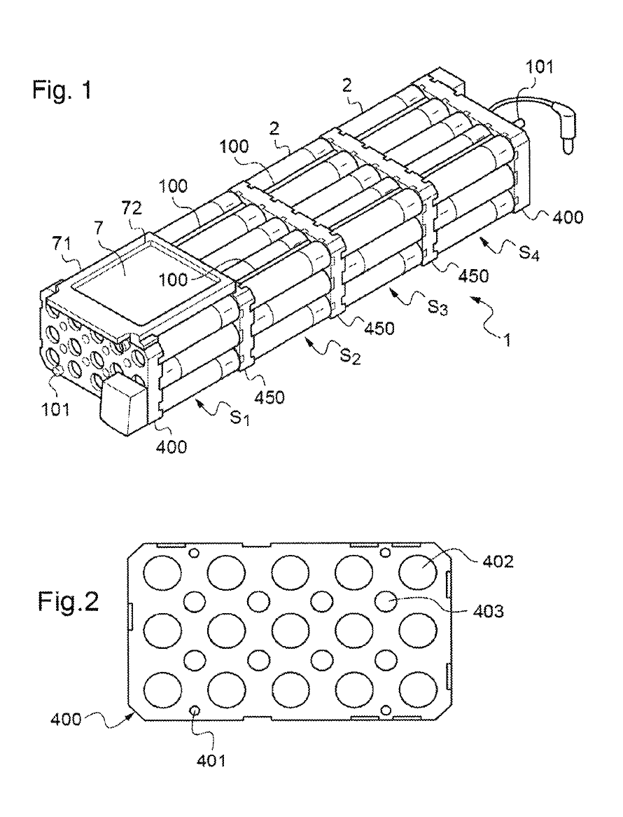

FIG. 1 is a view in perspective of an example of a battery 1 according to the invention. The battery 1 comprises several electrochemical accumulators 2 having first and second axial ends. First and second electrical connection terminals are made respectively at the first and second axial ends of the accumulators 2. The accumulators 2 are advantageously cylindrical and their axes are parallel. The accumulators 2 are, in this case, laid out in rows and columns.

The battery 1 comprises a charging and balancing circuit 7 connected to the accumulators 2. The circuit 7 is housed in a frame 71 having an aperture 72. When the battery 1 is housed inside a metal chassis of a motor vehicle, this chassis can be used as a heat sink to cool the battery or its components. Thus, a thermal conduction paste can be applied to the circuit 7 to create a thermal bridge between this circuit 7 and the chassis receiving the battery 1.

The battery 1 illustrated in FIG. 1 has four segments S1 to S4 of accumulators 2 held by five holders. The battery 1 comprises first and second holders 400 at its axial ends. The first and second holders 400 are electrically insulating. The insulating holders 400 are illustrated more precisely in FIGS. 2 to 4. The battery 1 furthermore has three intermediate holders 450. The holders 450 are also electrically insulating. The holders 450 are illustrated more precisely in FIGS. 7 to 9. Mounted rods 100 fixedly join all the holders 400 and 450 together. The mounted rods 100 extend over the length of the battery and are held by means of nuts 101 screwed into the threaded ends of the rods 100 and coming into contact against the external faces of the holders 400. The holders 400 and 450 are placed so as to be facing each other and are mechanically independent elements.

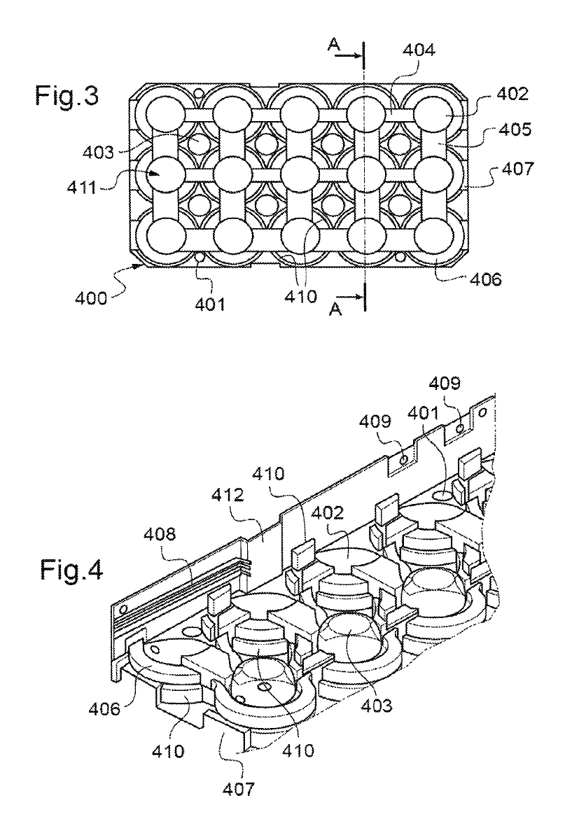

As illustrated in FIG. 3, the holders 400 comprise a plurality of recesses 411 designed to receive a respective end of an accumulator 2. Passages 404 and 405 are made between each recess 411 and the recesses adjacent to it. The FIGS. 7 to 9 represent an example of an intermediate holder 450 that can be used to form the battery of FIG. 1. As illustrated in FIGS. 7 and 8, the intermediate holder 450 comprises recesses 475 and recesses 485 formed so as to be facing each other. The apertures of these recesses are intended for receiving ends of respective accumulators 2. The accumulators of the segments S1 and S4 are thus held between the holder 400 and an intermediate holder 450, the accumulators of the segments S2 and S3 being held between the intermediate holders 450. Each accumulator 2 thus extends axially between two holders.

The accumulators of the segments S1 and S4 each have one axial end placed in a respective recess 411 of a holder 400 and the other axial end placed in a recess 475 or 485 of an intermediate holder 450. The accumulators of the segments S2 and S3 each have one axial end placed in a recess 475 of a holder 450 and their other axial end placed in a recess 485 of another intermediate holder 450.

Mounted rods 100 fixedly join all the holders 400 and 450 together as shall be described in detail here below. The mounted rods 100 extend along the axis of the accumulators 2 and make it possible to exert a holding force between the holders 400 along this axis.

The use of the intermediate holders 450 reinforces the modularity of the design of the battery 1. Thus, starting from components of batteries comprising two holders 400, it is possible to add a segment to a new design of the batteries by just adding an intermediate holder 450.

The use of mounted rods 100 simplifies the design of the battery 1. Indeed, a same holder model 400 and a same holder model 450 could be used for different models of batteries, comprising distinct accumulator lengths. This difference in length could be managed by using added-on batteries 100 of distinct lengths for these different models of batteries. Besides, the use of mounted or added-on rods 100 facilitates assembly. Indeed, the access to the terminals of the accumulators 2 is available before the assembling of the holders 400 and 450. Thus, the electrical connection of the terminals of an accumulator can be set up at both its ends. It is not necessary to use a wiring that would bring the connections of both terminals to a same end, thus increasing the cost of the battery.

As shall be described in detail here below, the recesses 411, 475 and 485 are configured to restrict the axial and transversal motions of the accumulators 2. The accumulators 2 thus held along the different axes by the holders 400 and 450 are separated by an air gap 102. Such an air gap 102 prevents the formation of thermal bridges between the accumulators 2, which could lead to chain destruction when one of them fails. Such an air gap 102 forms an excellent thermal and electrical insulator and enables the use of the accumulators 2 having an insulating sleeve of lower resistance or the use of accumulators without insulating sleeves. The air gap 102 formed between the accumulators 2 can for example have a thickness of 1 to 4 mm.

As illustrated more precisely in FIGS. 3 and 4, the recesses 411 have different surface areas that restrict the axial motions of the accumulators 2. Thus, each recess 411 has a bottom wall 406 forming an axial stop for an accumulator 2. The wall 406 has a bore 402 in its median part. The bores 402 enables access to be given to the connection terminals of the accumulators 2. The bores 402 especially make it possible to have available protective insulating hoods on the fastening screws 103 that attach the electrical connectors 300 to the connection terminals 201. Each recess 411 also has side walls 410 restricting the transversal motions of the accumulators 2. The holders 400 have through-bores 401. These bores 401 are to be crossed by the mounted rods 100. These through-bores 401 are advantageously disposed on the periphery of the holder 400.

The holders 400 also comprise through-bores 403 extending axially and disposed beside the recesses 411. The bores 403 enable an axial flow of air between the accumulators 2 optimizing their cooling. The bores 403 in particular favor the cooling of the accumulators 2 that are placed in the core of the battery 1 and intrinsically have lower cooling as compared with the accumulators 2 disposed on the periphery.

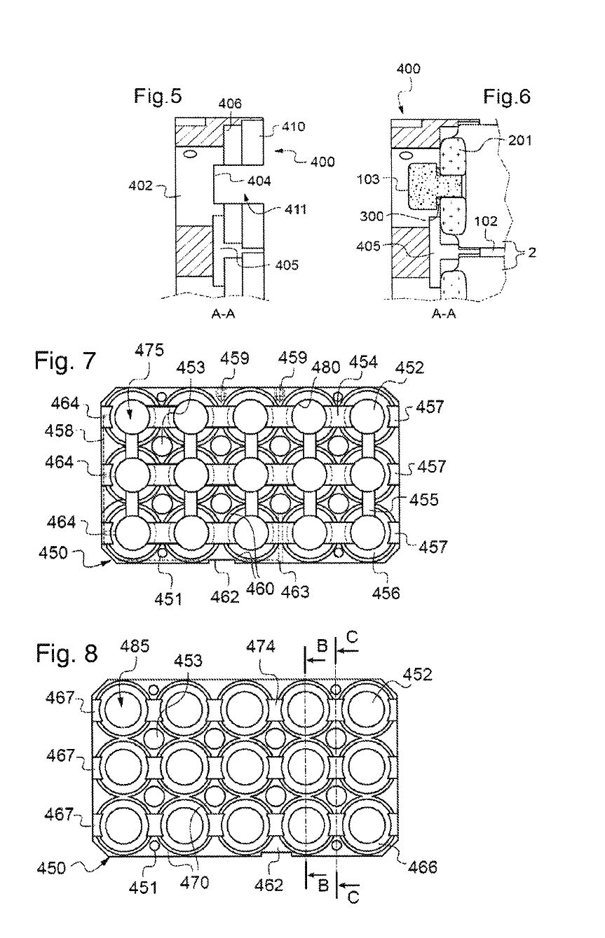

FIGS. 5 and 6 are views in section of details of the building of a holder 400, respectively in the absence and in the presence of the accumulators 2. As illustrated in FIG. 6, an electrical connector 300 is fixed to a connection terminal 201 of an accumulator 2. A screw 103 is screwed into the connection terminal 201 and places the electrical connector 300 flat against the connection terminal 201. The electrical connector 300 extends through the passages 404 of a same row to connect the terminals 201 of the accumulators 2 disposed along this same row. In placing, for example a connection terminal 300 at both ends of the accumulators 2 of a same row, all the accumulators of this row are connected in parallel.

Owing to the presence of the passages 404 and 405 between a recess 411 and each of the adjacent recesses, different configurations of electrical connection can be made at the holders 400. Thus, a same holder 400 will enable the forming of batteries 1 having very different configurations of electrical connection since it could house electrical connectors of very different configurations. The holders 400 will make it possible for example to connect all the accumulators 2 of a segment in parallel or to make several stages in series in a segment, depending on the configuration of the connectors 300.

Advantageously, the walls 410 are open-worked at the recesses 411 on the periphery of the holder 400. Thus, passages 407 are made on the periphery of the holder 400 and enable a transversal flow of air optimizing the cooling of the terminals of the accumulators 2.

Advantageously, the holders 400 have a channel 412 made on their periphery. The holders 400 also have grooves 408 made on their periphery and extending in a transversal plane between the channel 412 and holes (not shown) opening into recesses 411. The combination of the channel 412, the grooves 408 and these holes enable electrical connections to be made between the connectors 300 and the exterior, for example to obtain measurements of voltage or measurements of temperature. These electrical connections can be made by means of conductive wires housed in the grooves 408 and opening into the channel 412.

The holders 400 have threaded bores 409 at their periphery. These threaded bores 409 enable the battery 1 to be fixed to a frame, for example a motor vehicle chassis. The threaded bores 409 can also be used when assembling the battery 1 in order to facilitate their maintenance.

Advantageously, the holders 400 are identical, thus reducing the number of references of components needed to build a battery.

Advantageously, the recesses 411 are disposed in matrix form in the form of rows and columns, thus optimizing the compactness of the battery 1 for a given number of accumulators 2. The recesses 411 of a same row are connected by passages 404. The recesses 411 of a same column are connected by passages 405.

Advantageously, the passages 404 and 405 are deep enough for an electrical connector to be well-protected from external aggression. Advantageously, the passages 404 and 405 could have a depth approximately equal to half of the thickness of the holder 400 so that the electrical connectors are held at the core of the holder 400. Deep passages 404 and 405 also enable the housing of an electrical power connector such as current collector parallel to the end of the battery 1. Advantageously, the passages 404 and 405 are formed by grooves open towards the inner face of the holder 400 in order to facilitate the laying of electrical connectors between the terminals of the accumulators 2.

Advantageously, the passages 404 and 405 could have a width at least equal to half of the diameter of a recess 411 so that these passages can be crossed either by power connectors (series connection) or by balancing and protection connectors (parallel connection).

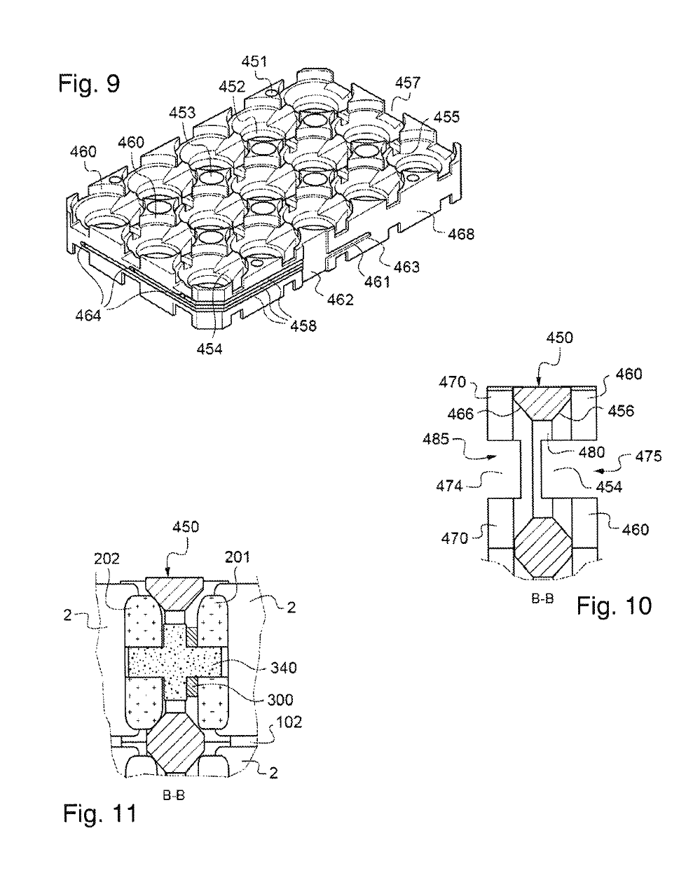

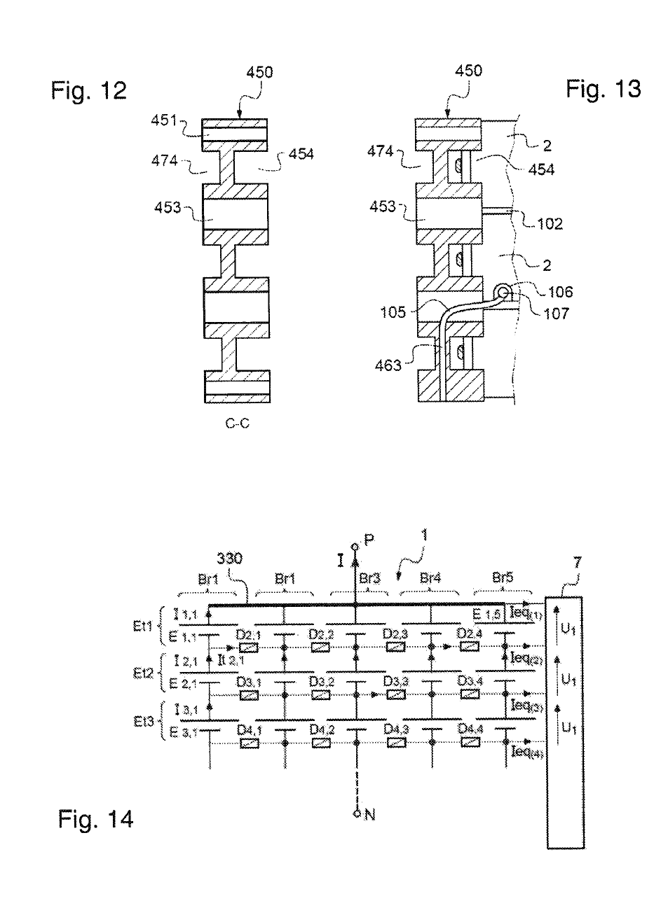

FIGS. 12 and 13 are views in section of details of building of a holder 450. As illustrated in FIG. 10, a recess 475 and a recess 485 facing each other are separated by a wall 480 of the holder 450. The wall 480 has a through-bore 452 formed in its median part. The bores 452 enable an electrical connection to be made between two adjacent segments of the battery 1.

An intermediate holder 450 has a first face in which the recesses 475 are made. The wall 480 demarcates an axial stop 456 at the bottom of a recess 475. This axial stop 456 restricts the axial motions of an accumulator, one end of which is housed in the recess 475. Each recess 475 also has a lateral wall 460 restricting the transversal motions of the accumulators 2.

Passages 454 and 455 are made between each recess 475 and the recesses adjacent to it. Owing to the presence of the passages 454 and 455 between a recess 475 and each of the adjacent recesses, different configurations of electrical connection can be made at the holders 450. Thus, a same holder 450 makes it possible to form batteries 1 having highly different electrical connection configurations since it could house electrical connectors of highly different configurations between their accumulators 2. Advantageously, the passages 454 and 455 are deep enough for an electrical connector to be well protected from external aggression. Advantageously, the passages 454 and 455 could have a depth approximately equal to half of the thickness of the holder 450 so that the electrical connectors are held in the core of the holder 450. Advantageously, the passages 454 and 455 could have a width at least equal to half of the diameter of a recess 475 or 485 so that these passages can be crossed either by power connectors (series connection) or by balancing and protection connectors (parallel connection). Advantageously, the passages 454 and 455 are formed by grooves that are open towards the inner face of the holder 450 in order to facilitate the placing of electrical connectors between the terminals of the accumulators 2.

The intermediate holder 450 has a second face in which the recesses 485 are made. The wall 480 demarcates an axial stop 466 in the bottom of a recess 485. This axial stop 466 restricts the axial motions of an accumulator, one end of which is housed in the recess 485. Each recess 485 also has side walls 470 restricting the transversal motions of the accumulators 2.

The axial stops 456 and 466 are advantageously inclined relatively to the transversal plane of the holder 450 in order to adapt more easily to geometrical variations of the accumulators 2, especially the variations between the axial supporting surface of the accumulator 2 and a connection terminal 201.

FIG. 11 is a view in section illustrating the electrical connection between two accumulators 2 belonging to two adjacent segments, for example S1 and S2. Two accumulators 2, the ends of which are housed respectively in a recess 475 and in a recess 485 of the intermediate holder 450 are aligned. The terminal 202 of one accumulator 2 is connected to the terminal 201 of the other accumulator 2 by means of a screw 340. The screw 340 has a shoulder coming into contact on the one hand with the terminal 202 and on the other hand with the connector 300. The screw 340 holds the connector 300 in contact with a terminal 201 in order to optimize the current passage section. The body of the screw 340 gives an optimized current passage section between the terminal 201 and the terminal 202. The shoulder of the screw 340 in contact with the terminal 202 also optimizes the current passage section. Such an electrical connection by screws 340 also reduces the weight of the connection in leading the current directly from one accumulator to another. The connector 300 goes through the passage 454 to connect the connector 201 to the connector 201 of an adjacent accumulator.

The holders 450 have through-bores 451. These bores 451 are to be crossed by mounted rods 100. These through-bores 451 are advantageously disposed on the periphery of the holder 450.

The holders 450 also comprise through-bores 453 extending axially and positioned between recesses 475 or 485. The bores 453 enables an axial flow of air between the accumulators 2, optimizing their cooling. The bores 453 in particular favor the cooling of the accumulators 2 that are placed at the core of the battery 1 and have an intrinsically lower cooling than that of the accumulators 2 disposed on the periphery.

Advantageously, the walls 460 are open-worked at the recesses 475 on the periphery of the holder 450. Thus, passages 457 are made on the periphery of the holder 450 and enable a transversal flow of air optimizing the cooling of the terminals of the accumulators 2. Similarly, the walls 470 are open-worked at the recess 485 on the periphery of the holder 450. Thus, passages 467 are made on the periphery of the holder 450 and enable a transversal flow of air optimizing the cooling of the terminals of the accumulators 2. Besides, passages 474 (shown more precisely in FIG. 12) are made between adjacent recesses 485. These passages 474 are aligned with passages 467 and therefore enable a transversal flow of air to be obtained through the holder 450 to optimize the cooling of the connections of the terminals of the accumulators 2.

Like the recesses of the end holders 400, the recesses 475 and 485 are positioned in rows and columns in a matrix. The recesses 475 and 485 and the bores 451 and 453 of an intermediate holder 450 have the same transversal positioning as the recesses 411 and the bores 401 and 403 of an end holder 400.

Bores 464 extend transversally between bores 452 and a border of the holder 450. The bores 464 pass transversally through walls 480 and open out into grooves 458 made on the periphery of the holder 458. The grooves 458 extend in a respective bore 464 up to a channel 462. The channel 462 extends axially on an edge of the plate 450.

The combination of the channel 462, the grooves 458 and the bores 464 enable electrical connections to be set up between connectors 300 and the circuit 7, for example to obtain measurements of voltage or measurements of temperature. These electrical connections can be made by means of conductive wires housed in the grooves 458 and opening into the channel 462.

The intermediate holder 450 furthermore has a bore 463 extending transversally to make a bore 453 communicate with an edge of the holder 450. This bore 463 opens into a groove 461. The groove 461 extends on a peripheral wall of the holder 450 between the channel 462 and the bore 463. As illustrated in FIG. 12, the bore 463 is crossed by a wire 105. This wire 105 passes through a bore 453 to reach the air gap 102 between two accumulators 2. This wire 105 is connected firstly to a temperature probe 107 and secondly to the circuit 7. The temperature probe 107 is held in contact against an accumulator 2 by means of a glue dot 106.

Besides, the intermediate holder 450 has threaded bores 459 on its periphery enabling the fastening of the battery to a frame or the fastening of the circuit 7 to the holder 450.

Besides, contrary to a technical prejudice well established in the field of batteries where there is a tendency to integrate a large number of protective elements around and between the accumulators, the battery 1 is advantageously without any peripheral wall fixedly joined to one of the holders 400 or 450. Thus, the holders 400 and 450 can easily be manufactured by molding without needing to have complex shapes. Besides, these holders 400 and 450 can be used for a large number of distinct batteries in reducing the time of design and manufacture of each new model of battery. The use of mounted rods 100 opens up, to the maximum extent, the median section of the accumulators 2 between the holders 400 and the holders 450. The cooling of the accumulators is then optimized.

Advantageously, the adjacent accumulators 2 disposed between the holders 400 or 450 are separated solely by the air gap 102 and no wall of material is interposed between these accumulators. Thus, the circulation of air between the accumulators 2 is favored, optimizing the cooling of the battery 1. Furthermore, the weight as well as the space requirement of the battery 1 can thus be reduced.

The absence of peripheral walls or the absence of material interposed between the accumulators 2 is advantageously combined with the use of accumulators 2 considered to be intrinsically very reliable in the event of malfunction, as is the case with Li—FePO4 type accumulators.

FIG. 14 represents the electrical connections in a battery 1 according to a particularly advantageous implementation of the invention. The battery 1 has a positive terminal P and a negative terminal N. The accumulators 2 of the battery 1 are disposed in five branches Br1 to Br5. An index j will here below correspond to the branch Brⱼ. Each branch Brⱼ comprises 12 accumulators E_{i,j} connected in series. The branch Br₁ comprises the accumulators E_{1,1}, E_{2,1}, E_{3,1}, E_{4,1} and E_{5,1}. An index i will here below correspond to a stage Etᵢ including five accumulators respectively belonging to each of the branches.

The accumulators of a same stage are parallel-connected by means of circuit-breakers. The term “circuit-breaker” generally designates an electrical protection switch which prevents or very strongly limits (for example by a factor 100) the passage of electrical current and carries out this interruption in the event of overload in order to protect the components with which it is connected. The sizing of the circuit-breakers of the illustrated example shall be described in detail here below.

The accumulators E_{i,j} of the first stage Et₁ are parallel-connected. The accumulators E_{i,j} are connected by their positive terminal to the terminal P of the battery 1. The connection of these positive terminals to the terminal P is advantageously done by large-section connectors such as a metallic collector bar 330 (described in detail here below) because this connection has a function of collecting parallel currents from the different branches. The negative terminals of the accumulators E_{1,j} of the first stage Et₁ are connected together by means of circuit-breakers. Thus, the circuit-breaker D_{2,1} connects the negative terminal of the accumulator E_{1,1} to the negative terminal of the accumulator E_{1,2}.

The accumulators E_{2,j} of the second stage Et₂ are also parallel-connected. The accumulators of a same stage i are, in practice, parallel-connected. For each of the intermediate stages, the positive terminals of the accumulators of a same stage are connected together by means of circuit-breakers and their negative terminals are also connected together by means of circuit-breakers.

As illustrated, each circuit-breaker is used for a parallel connection for two adjacent stages (two stages sharing connection nodes). Thus, the circuit-breaker D_{2,1} is used for the parallel connection of the accumulators E_{1,1} and E_{1,2} but also for the parallel connection of the accumulators E_{2,1} and E_{2,2}.

The connection of the negative terminals of the second stage (not shown) with the terminal N is advantageously achieved by large-section connectors such as the metallic collector bar 330.

The charging and charge-balancing circuit 7 is connected to the terminals of each of the stages. Those skilled in the art will determine an appropriate circuit 7 for carrying out the balancing of the voltages of the accumulators of each stage and managing the charging of each of the accumulators.

The current passing through an accumulator E_{i,j} is denoted as I_{i,j}. The current passing through a circuit-breaker D_{i,j} is denoted as It_{i,j}. The voltage at the terminals of a stage i is denoted as Uᵢ. The current exchanged by the positive terminals of a stage i with the charging and balancing circuit 7 is denoted as Ieq₍ᵢ₎.

Preferably, the invention uses iron-phosphate-based lithium-ion type accumulators 2 for their capacity of resistance to overvoltages and for the high operating security that they provide.

To ensure optimal protection of the accumulators, the circuit-breakers have a cut-off threshold below the maximum charging or discharging current tolerated for an accumulator. Besides, the cut-off threshold of the circuit-breakers is sized to conduct current when one of said accumulators forms an open circuit.

As described in greater detail in the patent application FR0903358, such a configuration makes it possible to:
limit losses by Joule effect in the battery 1;
reduce the cost of a highly secured battery 1;
ensure the continued operation of the battery despite a short-circuited accumulator;
ensure the continued operation of the battery despite a short-circuited accumulator by benefiting from compensation on all the accumulators that are as yet functional.

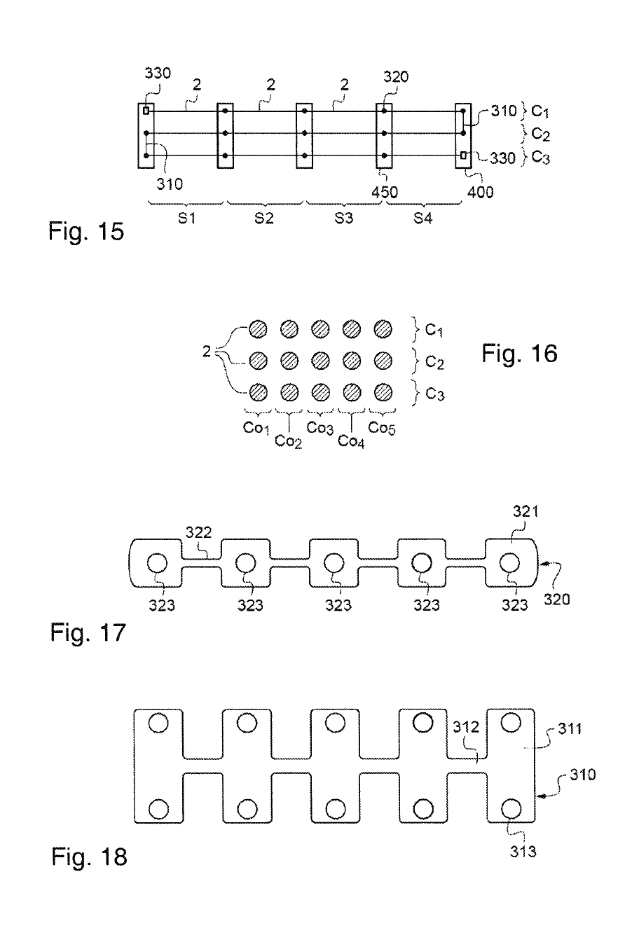

In the schematic representation of the battery 1 illustrated in FIGS. 14 and 15, the battery 1 comprises 12 series-connected stages. Each stage has five parallel-connected accumulators 2. The battery 1 thus has five parallel-connected branches. The accumulators 2 are laid out in three superimposed layers C1, C2 and C3, four aligned segments S1, S2, S3 and S4 and five attached columns Co1 to Co5.

At least two stages belonging to adjacent segments are series-connected. The accumulators of these series-connected stages are connected by distinct electrical connectors. For example, each accumulator of the segment S4 and the layer C1 is connected by a threaded screw 340 proper to an accumulator of the segment S3 and the layer C1.

It is also possible to envisage a case where each accumulator of a segment is series-connected by a distinct electrical connector to an accumulator of an adjacent segment. In the example, each accumulator of a layer is connected to the accumulator of a same layer but of an adjacent segment by means of a threaded screw 340 that is proper to itself. Thus, it is not necessary to collect the current from all the accumulators of one stage to lead it to the other stage in series. Thus, the resistance induced in the series-connection in a same layer is limited while, at the same time, there is the benefit of an optimal distribution of the current between the accumulators of a same stage.

In the example illustrated, the metal foils 310 and 320 ensure electrical connection in series between two adjacent stages. The metal foils 310 and 320 also ensure electrical connection in parallel of the different branches. Metal bars 330 form power collectors at each end of the battery 1.

The metal foils 310, one example of which is illustrated in FIG. 18 are intended for series-connecting two stages at an end holder 400. The foils 310 have elongated sections 311 enabling the series-connection of two stages laid out in superimposed layers of the battery 1. Each accumulator is therefore series-connected by a distinct elongated section 311 to an accumulator of the other stage. Thus, it is not necessary to collect the current from all the accumulators of one stage to lead it up to the other stage in series. Thus, all the levels of resistance induced by the series-connection of the stages in a same segment are limited while, at the same time, the benefit is obtained of an optimal distribution of the current between the accumulators of a same stage. The invention also avoids the use of a current-collecting component that has high space requirement because it has a large section. The elongated sections 311 are connected to one another by fuse sections 312. The fuse sections 312 have small width. Bores 313 are made at the ends of the elongated sections to enable the passage of the connection screws 601. The current in series between two stages is led through the elongated sections 311.

The metal foils 320, an example of which is illustrated in FIG. 17, are intended for series-connecting two stages at an intermediate holder 450. The foils 320 have contact plates 321 enabling the series-connection of two stages disposed in a same layer of the battery 1. The contact plates 321 are connected to one another by fuse sections 322. The fuse sections 322 are obtained in having a small width. Bores 323 are made in contact plates 321 to enable the passage of the threaded connection screws 340. The current in series between two stages is led through the thickness of the contact plates 321.

In one example of determining the width of the fuse sections 312 and 322, the width can be determined as follows.

It is assumed that the aim is to melt two fuse sections 312 and 322 in one second at a current of 30 A.

From the relationship I²·t=k·S², is assumed that the foil 310 has a thickness of 0.1 mm and is made out of copper. It is deduced from this that a width of 1 mm of the fuse sections 312 and 322 fulfils these conditions of melting.

An example for determining the width of the elongated section 311 can be determined as follows:

It is assumed that a Li-ion accumulator 2 is used, this accumulator having the possibility of providing a direct current of 60 A and having an internal resistance of 5 to 15 mΩ). In order to limit the serial losses in the elongated section 311, it is possible to fix a maximum resistance of 0.5 mΩ) through the elongated section 311. Assuming that the foil 310 has a thickness of 0.1 mm, that it is made of copper and shows a distance of 45 mm between the bores 313 of an elongated section 311, the following relationship makes it possible to deduce that an elongated section 311 with a width of 16 mm meets the maximum resistant threshold fixed at:

$$R = ρ \frac{L}{S}$$

R being the resistance of the elongated section 311, L the distance between the bores 313, ρ the resistivity of copper, and S the section of passage of the elongated section 311.

The metal foils 310 and 320 can easily be made by cutting out metal sheets under a press, for example copper or aluminum metal sheets.

The use of the foils 310 and 320 proves to be particularly advantageous since it limits the number of solders to be made in a battery 1 comprising a very large number of accumulators 2. Thus, the battery 1 can be made at a relatively reduced cost with high reliability of the electrical connections. Such a foil can be made at very low cost and makes it possible to limit the number of electrical connection parts between the different stages and the different branches of the battery 1.

Although we have described the use of foils to series-connect two stages of accumulators and to parallel-connect the different branches, it is also possible to envisage the formation of these connections by any other appropriate means. It is possible in particular to envisage making these connections by using printed circuits that pass through the passages between the recesses or by using metal tracks added on to the holders 400 and 450. The use of integrated circuits for the connection between two stages of accumulators enables the easy integration of the circuit-breaker function of the parallel connections in the form of re-settable fuses, making the maintenance of the battery particularly easy. The use of such an integrated circuit also makes it easier to make tracks for measuring voltage, connecting each branch of the control and charge-balancing circuit 7.

The different characteristics favoring the cooling of the accumulators 2 at the core of the battery 1 reduce the difference in temperature between the different accumulators 2. Thus, the electrical properties of the different accumulators are more homogenous, thus reducing the differences in charge and discharge between the different accumulators 2 and thus increasing the effective capacity of the battery 1. Furthermore, the invention thus also reduces the differences in service life between the different accumulators. These characteristics prove to be particularly advantageous for batteries comprising at least three segments, three columns and three layers, at least one accumulator 2 being then enclosed between other accumulators 2.

Those skilled in the art will easily be able to determine an appropriate insulating material to constitute the holders 400 and 450. Apart from its properties of electrical insulation, such a material must have a modulus of elasticity and a coefficient of thermal expansion compatible with the constraints induced by the battery 1: namely supporting the accumulators 2 with reduced deformation, presenting limited deformation during heating or again withstanding the forces applied by the mounted rods 100. The holders 400 and 450 could for example be made out of PEEK (polyetheretherketone) or PPS (polyfenilsulfide) belonging to the inflammability class V0.

Although not illustrated, insulating caps are advantageously placed on the electrical connection screws placed at the ends of the battery 1.

1-12. (canceled)

13. An apparatus comprising a battery, said battery comprising first electrochemical accumulators having first and second axial ends having respective first and second electrical connection terminals formed thereon, second electrochemical accumulators having first and second axial ends having respective first and second electrical connection terminals formed thereon, first and second holders disposed so as to be facing each other, a third holder disposed so as to be facing said second holder, wherein said first, second, and third holders are electrically insulating, wherein each holder comprises recesses and passages made between each recess and recesses adjacent to said recess, said second holder comprising a plurality of recesses made in a first face and a plurality of recesses made in a second face, said recesses of said first and second faces facing each other and communicating by through-bores, said first axial ends of said first electrochemical accumulators being placed in a respective recess of said first holder, said second axial end of the first electrochemical accumulators being placed in a respective recess of said second holder, said first axial end of said second electrochemical accumulators being placed in a respective recess of said second face of said second holder, said second axial end of said second electrochemical accumulators being placed in a respective recess of said third holder, said recesses being configured to restrict axial and transverse motions of said electrochemical accumulators and to maintain separation of said electrochemical accumulators by an air gap, each holder comprising side walls restricting transverse motions of said electrochemical accumulators in the recesses in which said passages between said adjacent recesses are formed by grooves passing through lateral walls thereof, at least one mounted rod fixedly joining said first and second holders, at least one mounted rod fixedly joining said second and third holders, at least one first electrical connector passing through one of said passages of said first holder and electrically series-connecting two adjacent electrochemical accumulators among said first electrochemical accumulators, at least one second electrical connector passing through one of said passages of said third holder and electrically series-connecting two adjacent electrochemical accumulators among said second electrochemical accumulators, third electrical connectors, said first electrochemical accumulators comprising at least one first stage of electrically parallel-connected electrochemical accumulators, said second electrochemical accumulators comprising at least one second stage of electrically parallel-connected electrochemical accumulators, each electrochemical accumulator of said first stage being series-connected to an electrochemical accumulator of said second stage by a third distinct electrical connector by a through-bore.

14. The apparatus of claim 13, wherein said holders lack walls surrounding a median part of said electrochemical accumulators.

15. The apparatus of claim 13, wherein median parts of two adjacent electrochemical accumulators are separated only by an air gap.

16. The apparatus of claim 13, wherein each holder comprises at least one through-hole extending in parallel to said electrochemical accumulators and disposed between recesses of said holder so as to open into an air gap between said electrochemical accumulators.

17. The apparatus of claim 13, wherein each holder comprises at least one passage extending transversally between a recess and a periphery of said holder.

18. The apparatus of claim 13, wherein said first electrochemical accumulators comprise at least two stages of electrically series-connected electrochemical accumulators, said two stages each comprising at least two electrically parallel-connected electrochemical accumulators, said first electrical connector comprising a metal plate that connects said stages in series and that connects said electrochemical accumulators of said two stages in parallel, said metal plate comprising a fuse section forming said parallel connection and passing through one of said passages between adjacent recesses.

19. The apparatus of claim 18, wherein said fuse section is sized to open an electrical connection between two of said electrochemical accumulators in parallel when one of said electrochemical accumulators is short-circuited.

20. The apparatus of claim 18, wherein said fuse section is sized to conduct current when one of said parallel-connected electrochemical accumulators forms an open circuit.

21. The apparatus of claim 18, further comprising a charging and charge-balancing circuit connected to terminals of each of said series-connected stages.

22. The apparatus of claim 13, wherein said holders have a thickness, and wherein said passages between adjacent recesses extend up to half of said thickness.

23. The apparatus of claim 13, wherein said recesses of a holder are laid out in a matrix of rows and columns.

24. The apparatus of claim 13, wherein each of said first electrochemical accumulators is series-connected to one of said second accumulators by a third distinct electrical connector.
